(19) United States
(12) Patent Application Publication
(10) Pub. No.: US 2020/0256685 A1
(43) Pub. Date: Aug. 13, 2020

(54) METHOD AND SYSTEM FOR LOADING DIGITAL GEOGRAPHICAL MAP TILES

(71) Applicant: Robert Bosch GmbH, Stuttgart (DE)

(72) Inventors: Oliver Kamphenkel, Lehrte (DE); Roland Homeier, Wennigsen (DE)

(21) Appl. No.: 16/650,637

(22) PCT Filed: Sep. 21, 2018
(86) PCT No.: PCT/EP2018/075657

§ 371 Date: Mar. 25, 2020

(30) Foreign Application Priority Data
Oct. 13, 2017 (DE) 10 2017 218 394.2

(51) Int. Cl. G01C 21/34; H04W 4/024; H04W 4/02; G01C 21/36; G05D 1/02

(52) U.S. Cl. CPC G01C 21/3407; H04W 4/024; G05D 2201/0213; G01C 21/3694; G05D 1/0276; H04W 4/027

(57) ABSTRACT

A method for loading digital geographical map tiles by an autonomous or semi-autonomous vehicle from an external server unit. A present speed of the vehicle and a link quality of a data link to an external server unit presently available for the vehicle are ascertained. A territory size to be loaded by the vehicle for a planned driving route is calculated as a function of the speed of the vehicle and the link quality of the vehicle to the at least one external server unit, and a list of map tiles to be loaded is created based on the territory size to be loaded, excluding map tiles already stored in a control unit of the vehicle. A prioritized order of the listed map tiles to be loaded is ascertained, and the map tiles are loaded in the prioritized order.

### FIELD

The present invention relates to a method and to a system for loading digital geographical map tiles by an autonomous or semi-autonomous vehicle from an external server unit.

### BACKGROUND INFORMATION

For the autonomous operation of vehicles including highly automated driving functions, the vehicles require highly precise geographical data of the route to be traveled. The digital geographical data and their up-to-dateness are safety relevant for the operation of the automated driving functions. An inquiry as to the data is made dynamically by the vehicle to a map server as needed, and the data are downloaded.

At present, the use of highly automated driving functions is only possible up to a particular maximum speed, which is considerably below the top speed of a vehicle. Unless the vehicle has sufficient geographical data for a planned driving route which describe the further course of the driving route in detail, the vehicle has to be steered manually by a driver. The required map tiles are loaded from the map server while the vehicle is stopped or driven manually. As soon as a sufficient territory in the form of map data has been loaded into the map memory of the vehicle, and if the vehicle does not drive faster than the maximum speed of the automated driving function, the automatic driving function is enabled for the driver to switch on. In the related art, a statistical territory size situated within a defined radius around the instantaneous position of the vehicle is predefined as a sufficient territory of the map data. The map data stored in the map memory of the vehicle must be checked cyclically for up-to-dateness by corresponding map server inquiries, until the map data are no longer needed and may be discarded. While the vehicle is in motion, the map tiles to be newly loaded are cyclically calculated and reloaded. At very high speeds, an accordingly high need for map tiles to be newly loaded arises to be able to represent the routing. However, the speed of the vehicle potentially negatively affects the quality of the link to the map server. As a result of such an unstable data link, reliable reloading of the map tiles may no longer be possible. In present systems, the reloading of the map tiles continues to be carried out despite a low link quality, which may result in overloading of the data channel and a data loss resulting therefrom. As an alternative, present systems stop the reloading of the map data since automated driving is presently not possible at high speeds.

### SUMMARY

An object of the present invention is to provide a method and a system which allow digital map data to be loaded even at high speeds of a vehicle.

This object may be achieved in accordance with an example embodiment of the present invention. Advantageous embodiments of the present invention are described herein.

According to one aspect of the present invention, an example method for loading digital geographical map tiles by an autonomous or semi-autonomous vehicle is provided. For this purpose, an instantaneous speed of the vehicle is ascertained. Moreover, a link quality of a data link to an external server unit which is presently available for the vehicle is ascertained. Thereafter, a territory size to be loaded for a planned driving route is calculated by the vehicle as a function of the speed of the vehicle and the link quality of the vehicle to the at least one external server unit. A list of map tiles to be loaded is ascertained based on the territory size to be loaded, excluding map tiles already stored in a control unit of the vehicle. Finally, a prioritized order of the listed map tiles to be loaded is determined, and the map tiles in the previously determined prioritized order by the vehicle are loaded by an external server unit.

The example method according to the present invention makes it possible to adapt the geographical data volume to be requested by the vehicle, taking the instantaneous speed and the instantaneous stability of the data link between the vehicle and the external server unit into consideration. At high speeds, for example, the radius of the map data territory to be loaded may be decreased with increasing speed during manual operation of the vehicle. In this way, reliable loading of the requested map tiles is made possible, and unnecessary inquiries to the map server are avoided. At low speeds, such as during a traffic congestion, the radius of the map data territory to be loaded is decreased.

The time factor is taken into consideration as a criterion for the volume of the map data to be loaded. Unnecessary inquiries as to the up-to-dateness of the loaded map data are minimized since the map data are only requested when the territory is reachable for the vehicle at the instantaneous speed in a defined time frame.

Furthermore, a prioritized order for downloading newly required map tiles from an external server unit may be established with the aid of the example method. This allows the vehicle to continue to procure the map tiles which are required most urgently, for example, for the routing of the planned driving route of the vehicle even at higher speeds and with a low transmission rate of the data link. The downloading of map tiles which potentially represent surroundings of the direct planned driving route may be assigned a lower prioritization, and a procurement of the map data of these map tiles may be postponed to a point in time with a stable data link. Values of transmission rates may be established in the process, at which map tiles having a particular prioritization are downloaded. Map tiles having the prioritization level 1 may continue to be requested by the vehicle from the external server unit even on route sections with a weak data link or when driving at high speed. Map tiles having the prioritization level 3 are transmitted, for example, at lower speeds customary in the autonomous driving mode and a resulting more stable data link. The comparison to map tiles already present in the vehicle memory prevents identical map tiles of the same territory from being loaded multiple times and stored in the vehicle memory. This may additionally reduce the requested data volume.

The example method makes it possible to be able to download map material of a planned driving route required for the autonomous driving mode of a vehicle even during route sections having a lower radio network coverage or during trips having a higher travel speed. As a result of minimizing or increasing the territory size to be loaded with the aid of map tiles as a function of the quality of the data link and the speed of the vehicle, and classifying the respective map tiles according to their relevance for the planned driving route, a reduction of the data volume to be loaded may be achieved. The drastically minimized data volume as a result of the method may thus also be transmitted at low data transmission rates.

According to one exemplary embodiment, the territory size represented by map tiles and to be loaded is dynamically increased or decreased. For this purpose, the link quality for the data transmission between the vehicle and the external server unit may be ascertained continuously or at regular intervals, and the territory size to be loaded may be flexibly adapted. At high speeds, the radius of the map data territory to be loaded is decreased with increasing speed, whereby fewer map tiles have to be requested. In this way, reliable loading of the requested map tiles becomes possible, and unnecessary inquiries to the external server unit, which could slow a data transmission or overload the system at low transmission rates, are avoided.

According to one further exemplary embodiment of the present invention, a territory size to be loaded is minimized with increasing speed during the manual operation of the vehicle. The autonomous driving mode of a vehicle is presently only possible up to a particular maximum speed. Moreover, data links of vehicles have a lower transmission quality during the data transmission with increasing speed. Once the maximum speed of the autonomous driving function of a vehicle has been reached, the driver may switch to the manual operation. At the same time, the territory size to be loaded in the form of map tiles may be reduced to compensate for the decrease in the transmission rate of the data link to be expected at a higher speed. A possible interruption of the transmission of map tiles relevant for the routing may thus be prevented.

According to one further specific embodiment of the present invention, the territory size to be loaded is maximized at a moderate speed of the vehicle and with a stable data link between the vehicle and the external server unit. At a speed of the vehicle below the maximum speed of the autonomous driving function, a stable data transmission with a high possible transmission rate is to be assumed. During the manual or autonomous driving operation below the maximum speed limit of the autonomous driving function, the territory size to be loaded is thus preferably maximized to utilize the high transmission rate for downloading a preferably large number of map tiles. Map tiles having a low prioritization level are also downloaded by the external server unit in the process. During downloading, the prioritized order of the map tiles is preferably maintained, despite high available transmission rates. This ensures that, initially, the map tiles most relevant for the routing are loaded in the event that an abrupt worsening of the transmission speed occurs, for example due to a lack of radio network coverage. In this way, the geographical data of the planned routing which are absolutely necessary for the autonomous driving function are preferably loaded and are promptly available to the vehicle.

According to one further exemplary embodiment of the present invention, only the map tiles of the territory in the immediate surroundings of the vehicle are loaded during a low speed of the vehicle. At low speeds of the vehicle, such as in a congestion, the radius of the territory size to be loaded and represented by the map tiles is preferably decreased. In this way, the time factor may be taken into consideration as a criterion for the volume of the map data to be loaded. Repeated inquiries as to the same map tiles and unnecessary checking of the up-to-dateness of the loaded map data are thus minimized since the map data are only requested when the territory is reachable for the vehicle at the present speed in a defined time frame. In this way, the transmitted data volume may be reduced, and the repeated downloading of the same map tiles may be avoided. The system may thus be relieved, and the storage of unnecessary data in the vehicle memory may be prevented.

According to one further exemplary embodiment of the present invention, the map tiles to be loaded are prioritized according to their relevance for a driving route of the vehicle. Priority levels are preferably assigned to the map tiles to be loaded of a territory in the surroundings of the vehicle. Map tiles having the highest prioritization level are loaded first from the external server unit. When the downloading of all map tiles having the highest priority level is completed, the map tiles having the lower priority levels follow according to their prioritized order. The categorization of the map tiles into the priority levels takes place according to their relevance for the driving route of the vehicle, preferably when driving using the autonomous driving function. For example, map tiles which will be passed through next by the vehicle based on the planned routing may be assigned a high priority level.

According to one further exemplary embodiment of the present invention, map tiles which are passed through by the planned driving route of the vehicle are preferred in the prioritization of a loading order. In this way, it is ensured that, initially, the direct routing of the planned driving route of the vehicle is downloaded by the external server unit and, for example, is provided for the autonomous driving function. Afterwards, further map tiles having a lower prioritization, for example from the surroundings of the direct routing, map tiles of parking facilities or alternative routes in the event of a congestion, may be downloaded. This ensures that, in the case of a stable data link to the external server unit, initially the map tiles which are absolutely necessary for representing the planned driving route by the vehicle and, in particular, for the autonomous driving function, are loaded onto the vehicle memory.

According to one further specific embodiment of the present invention, the map tiles which are registered over an extended time period of the course of the trip in an area relevant for the vehicle are preferably loaded. Map tiles which are completely passed through, for example, from north to south, have a higher relevance for the driving route than map tiles which are only passed through by the vehicle in a small boundary area. The longer the planned driving route of the vehicle on the map tile is, the more relevant it is to the course of the trip of the vehicle. Relevant map tiles are thus given a high prioritization level and are preferably downloaded by the external server unit.

According to one further specific embodiment of the present invention, map tiles loaded during the manual operation of the vehicle are provided for the autonomous driving function by a deceleration and a switch into an autonomous mode of the vehicle. The downloaded map tiles are provided in the vehicle memory in such a way that they are promptly available for the autonomous driving function. The prioritized loading order of the map tiles ensures that the autonomous driving function promptly has the most relevant map tiles for it available. The map tiles having the highest priority may, for example, be the nearest map tiles which will presumably be passed through next due to the planned driving route of the vehicle. Map tiles through which long route segments of the planned driving route extend may also have a high priority.

Another object of the present invention is to provide an example system for providing digital geographical map tiles and for carrying out the method. The example system includes an external server unit and at least one autonomous or semi-autonomous vehicle which is suitable for loading digital geographical map tiles from the external server unit. The example system furthermore includes a unit for regulating the territory size, a unit for identifying map tiles, and a unit for prioritizing map tiles relevant for a driving route of a vehicle and for establishing an order for loading the prioritized map tiles.

The unit for regulating the territory size calculates the size of the territory of the digital geographical map data to be instantaneously loaded from the instantaneous speed of the vehicle and from the instantaneous quality of the data link to the external server unit. It is taken into consideration in the process that the quality of the data link to an external server unit decreases with increasing speed of a vehicle. For this purpose, the size of the territory to be loaded in the form of map tiles may be maximized with increasing speed, for example at speeds below the maximum speed of the autonomous driving function. When the maximum speed of the autonomous driving function has been reached, the size of the territory to be loaded remains constant as long as this is possible. As soon as a speed of the vehicle has been reached at which the number of the map tiles to be newly loaded is so high that it is no longer possible to load them reliably, the size of the territory to be loaded is reduced again with increasing speed. The unit for identifying map tiles calculates a list of the map tiles to be newly loaded from the size of the territory to be loaded and the map tiles already present in the memory. The unit for prioritizing the map tiles sorts the list of the map tiles to be newly loaded based on the geographical data present in the map memory which are already known.

Preferred exemplary embodiments of the present invention are described in greater detail hereafter based on highly simplified schematic representations.

### BRIEF DESCRIPTION OF THE DRAWINGS

FIG. 1 shows a map having a territory size to be loaded according to a method according to the present invention.

FIG. 2 shows a map to illustrate a shift of the territory size to be loaded as a function of a vehicle position and a prioritization of map tiles to be loaded.

FIG. 3 shows a dependence of a territory size to be loaded on a speed of a vehicle.

FIG. 4 shows a schematic flow chart of the method according to one specific embodiment.

FIG. 5 shows a schematic flow chart of a prioritization process of map tiles.

### DETAILED DESCRIPTION OF EXAMPLE EMBODIMENTS

In the figures, the same design elements in each case have the same reference numerals.

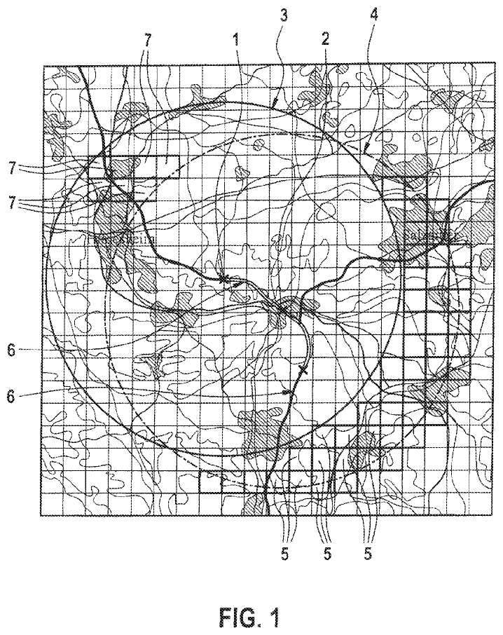

FIG. 1 shows a map having a territory size to be loaded according to a method according to the present invention. A vehicle covers a route from a first position 1 to a second position 2. First position 1 forms the center of a first radius of a first territory size 3 to be loaded, and second position forms the center of a second radius of a second territory size 4 to be loaded. The territory sizes are divided into map tiles 5. Over the course of a driving route 6, the center of the first radius of first territory size 3 to be loaded shifts to the center of the radius of second territory size 4 to be loaded. During a shift of the territory to be loaded in the direction of second position 2, new map tiles 5 must be loaded by the vehicle. Map tiles 7 no longer required may be deleted from a vehicle memory, provided they are no longer needed for further routing 6.

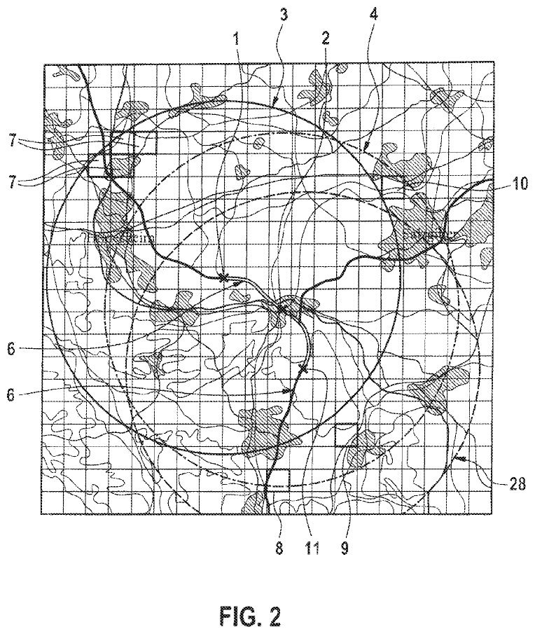

FIG. 2 shows a map to illustrate a shift of territory size 3, 4 to be loaded as a function of a vehicle position 1, 2, 11 and a prioritization 8, 9, 10 of map tiles 5 to be loaded. To keep a data volume of geographical pieces of information to be transmitted, which, for example, are necessary for an autonomous driving function of a vehicle, preferably low, a prioritization 8, 9, 10 may be assigned to map tiles 5 to be loaded during a loading order. Depending on the relevance of map tiles 5 to be loaded for driving route 6 of the vehicle, map tiles 5 are assigned a high or a low priority 8, 9, 10.

According to the exemplary embodiment, driving route 6 extends directly through map tile 8. Map tile 8 is thus assigned a high priority level, so that map tile 8 is preferentially loaded by the vehicle. Map tile 9 is assigned a medium priority level since it leads from direct driving route 6 onto a secondary road. Even though map tile 10 is situated within territory size 4 to be loaded, it is only of subordinate relevance for further driving route 6 of the vehicle. Map tile 10 is thus assigned a low priority level.

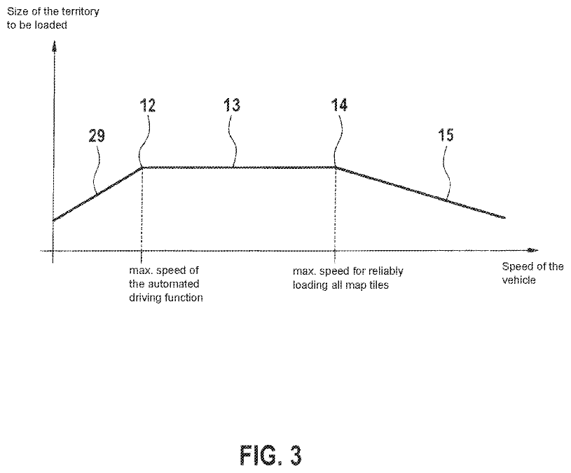

FIG. 3 shows a dependence of a territory size 4 to be loaded on a speed of a vehicle. At speeds below the maximum speed of an autonomous driving function 12, the size of the territory to be loaded increases 29 with increasing speed. When the maximum speed of autonomous driving function 12 has been reached, the size of the territory to be loaded remains constant 13 as long as a reliable loading of new map tiles is possible. As soon as a speed of the vehicle has been reached at which the number of the map tiles to be newly loaded reaches a degree at which it is not possible to ensure reliable loading 14 of new map tiles 8, 9, 10, territory size 3, 4, 28 to be loaded is minimized 15 with increasing speed. When the speed is decelerated to below the maximum speed of an autonomous driving function 12 so that a reliable downloading of larger data volumes is ensured, territory size 3, 4, 28 to be loaded may be increased 15 again.

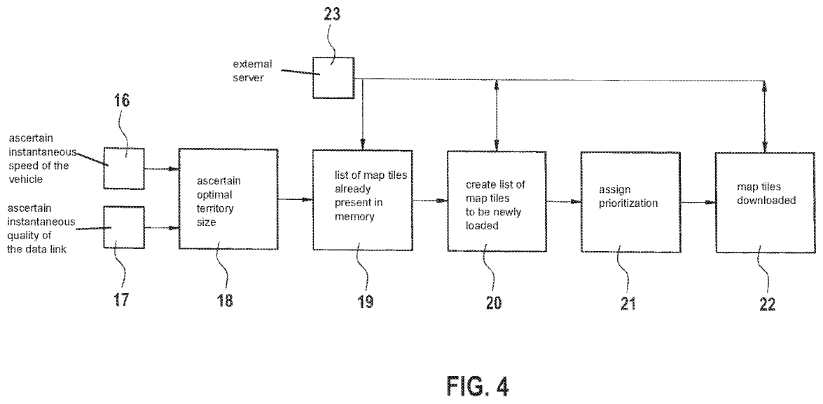

FIG. 4 shows a schematic flow chart of the method according to one specific embodiment. Initially, an instantaneous speed of vehicle 16 and an instantaneous quality of data link 17 to an external server unit 23 are ascertained. Taking the instantaneous speed of vehicle 16 and the instantaneous quality of data link 17 into consideration, the optimal territory size to be loaded of territory 18 to be loaded is ascertained. The optimal territory size 18 to be loaded may be ascertained based on the speed, for example. Afterwards, a list of map tiles 20 to be newly loaded from external server unit 23 is created from the size of the optimal territory size 18 to be loaded and map tiles 19 already present in the memory. Map tiles 20 to be newly loaded are assigned a prioritization 21 corresponding to their relevance for the driving route. Finally, map tiles 8, 9, 10 to be newly loaded are downloaded 22 by external server unit 23 in the prioritized order 21 so that, in the case of a data link having low transmission rates, map tiles 8 most relevant for the driving route are downloaded first. Map tiles 9, 10 having a lower assigned priority level are not loaded until the quality of the data link improves and/or all map tiles having a higher priority level 8 have already been downloaded.

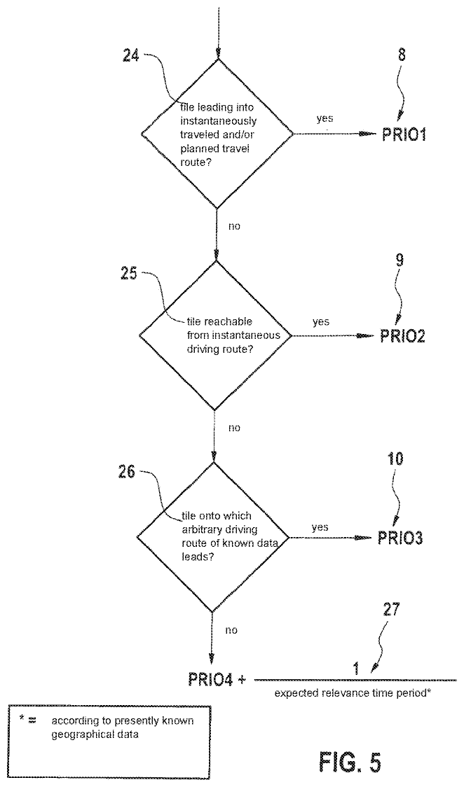

FIG. 5 shows a schematic flow chart of a prioritization process of map tiles. According to the exemplary embodiment, map tiles leading 24 into the instantaneously traveled and/or planned driving route 6 have the highest priority level PRIO1 8. When a driving route 6 leads into a map tile to be newly loaded which, according to the known geographical data, is reachable 25 from instantaneous driving route 6, this map tile is given priority PRIO2 9. Third-highest priority PRIO3 10 is given to map tiles onto which an arbitrary driving route of presently known data leads 26. All other map tiles are given a priority which is calculated as PRIO4+1/expected relevance time period 27. These map tiles are given an order which depends on the expected time period of their relevance for the geographical data. This time period may, for example, be calculated based on the already known geographical data and the planned continuing travel on the instantaneous driving route 6. Finally, a list of the prioritized map tiles to be newly loaded is created 22, and the map tiles are downloaded in prioritized order 21 by external server unit 23.

1-10. (canceled)

11. A method for loading digital geographical map tiles by an autonomous or semi-autonomous vehicle from an external server unit, the method comprising the following steps:
ascertaining a present speed of the vehicle;
ascertaining a link quality of a data link, to an external server unit, which is presently available for the vehicle;
calculating a territory size to be loaded by the vehicle for a planned driving route as a function of the speed of the vehicle and the link quality of the vehicle to the at least one external server unit;
calculating a list of map tiles to be loaded based on the territory size to be loaded, excluding map tiles already stored in a control unit of the vehicle;
ascertaining a prioritized order of the listed map tiles to be loaded; and
loading the map tiles in the prioritized order.

12. The method as recited in claim 11, wherein the territory size represented by map tiles and to be loaded is dynamically increased or decreased.

13. The method as recited in claim 11, wherein the territory size to be loaded is minimized with increasing speed during manual operation of the vehicle.

14. The method as recited in claim 11, wherein the territory size to be loaded is maximized at a moderate speed of the vehicle and a stable data link between the vehicle and the external server unit.

15. The method as recited in claim 11, wherein only the map tiles of the territory in the immediate surroundings of the vehicle are loaded during a low speed of the vehicle.

16. The method as recited in claim 11, wherein the map tiles to be loaded are prioritized according to relevance for a driving route of the vehicle.

17. The method as recited in claim 16, wherein map tiles which are passed through by the planned driving route of the vehicle are preferred in the prioritization of a loading order.

18. The method as recited in claim 16, wherein map tiles which are registered over an extended time period of a course of a trip in an area relevant for the vehicle are loaded.

19. The method as recited in claim 11, wherein map tiles loaded during the manual operation of the vehicle are provided to the vehicle for the autonomous driving by a deceleration and a switch into an autonomous mode.

20. A system for providing digital geographical map tiles, comprising:
at least one external server unit; and
at least one autonomous or semi-autonomous vehicle configured to load digital geographical map tiles from the external server unit, the vehicle including a unit for regulating the territory size, a unit for identifying map tiles, and a unit for prioritizing map tiles relevant for a driving route of a vehicle and for establishing an order for loading the prioritized map tiles.
